(19) United States
(12) Patent Application Publication
(10) Pub. No.: US 2026/0307655 A1
(43) Pub. Date: Oct. 8, 2026

(54) Method for Operating a Drive System of a Work Machine

(71) Applicant: Robert Bosch GmbH, Stuttgart (DE)

(72) Inventors: Jordi Glas, Unna (DE); Frederik Fertig, Wertheim (DE); Matthias Baumann, Ulm (DE)

(21) Appl. No.: 19/636,627

(22) Filed: Apr. 1, 2026

(30) Foreign Application Priority Data
Apr. 2, 2025 (DE) 10 2025 112 868.5

(51) Int. Cl. B60W 30/188; B60W 10/06; B60W 10/08; B60W 10/30

(52) U.S. Cl. CPC B60W 30/1886; B60W 10/06; B60W 10/08; B60W 10/30; B60W 2510/0638; B60W 2510/0666; B60W 2710/0644; B60W 2710/086; B60W 2710/305

(57) ABSTRACT

A method for operating a drive system of a work machine is disclosed. The work machine includes a combustion engine, in particular a diesel engine, an electric generator, an electric DC link and a plurality of consumers with an electric drive. The combustion engine is coupled to the electric generator to drive it. The electric generator is connected via the DC link to the electric drives of the consumers to supply them with electric energy. The combustion engine is regulated by a speed control corresponding to a setpoint speed. A total power of the combustion engine available in the DC link is determined. A respective consumer power is assigned to each consumer of the plurality of consumers, so that the sum of the consumer powers is equal to the available total power. The plurality of consumers includes at least one first consumer. For each consumer of the at least one first consumer, an adjustment value is determined from a control difference between an actual speed of the combustion engine and the setpoint speed and an actuating value of the electric drive is determined from the consumer power assigned to the respective first consumer and the adjustment value.

This application claims priority under 35 U.S.C. § 119 to patent application no. DE 10 2025 112 868.5, filed on Apr. 2, 2025 in Germany, the disclosure of which is incorporated herein by reference in its entirety.

The present disclosure relates to a method for operating a drive system of a work machine, as well as a computing unit and a computer program for its execution.

### BACKGROUND

In mobile work machines, complete electrification is proving to be difficult to implement when considering typical work cycles, since the volumetric energy density of batteries is significantly lower than that of fossil fuels. For example, in agricultural vehicles, very large energy storage units are required to be able to realize typical work cycles without interruption. Therefore, especially in applications that require high power over a long period of time with as little interruption as possible, fossil fuels are often still used. However, since electric drives usually have a higher efficiency and electric drives are typically superior to conventional drives with regard to their controllability and control quality, hybrid or series-electric systems are used here.

### SUMMARY

A method for operating a drive system of a work machine, as well as a computing unit and a computer program for carrying out the method are set forth below. Advantageous configurations are also the subject of the following description.

The disclosure is based on a drive system of a work machine in which a combustion engine coupled with a generator supplies several consumers, each having an electric drive, with electric power via an electric DC link, and in which the combustion engine is regulated by a speed control corresponding to a setpoint speed.

Within the scope of the disclosure, a total power of the combustion engine available in the DC link is now determined, a respective consumer power is assigned to each consumer such that the sum of the consumer powers is equal to the available total power, for at least a first consumer an adjustment value is determined by a controller from a control difference between an actual speed and the setpoint speed of the combustion engine, and an actuating value for the electric drive is determined from the consumer power assigned to the first consumer and the adjustment value. By the proposed measure, a stable operation of the combustion engine up to its maximum power or power limit can be ensured without an electric buffer storage (e.g., a battery).

The work machine is in particular a mobile work machine, wherein e.g. a consumer drives a drive train or travel drive of the mobile work machine. The drive system can be considered a hybrid drive system. The control difference is in particular the difference between the actual speed of the combustion engine and the setpoint speed of the combustion engine or an equivalent value.

The available total power is in particular the power that can be provided by the combustion engine or is available, minus a power loss of the generator and/or a rectifier, via which the generator is connected to the DC link, and/or a mechanical power loss (e.g. friction), i.e., the available mechanical power of the combustion engine (e.g., at an output shaft of the combustion engine) minus the power loss of the generator and/or the rectifier and/or mechanical power losses. The available mechanical power of the combustion engine and thus the available total power can, e.g., be dependent on the speed and/or a maximum rate of change of the power at the current operating point, wherein the current operating point is given or characterized by the actual speed and/or an actual torque.

According to one configuration, when determining the available total power, a maximum power is determined which can be delivered by the combustion engine at the actual speed, wherein the available total power is determined as less than or equal to the maximum power at the actual speed. In particular, a characteristic curve of the combustion engine can be used, from which a maximum power can be determined for each speed, which can be delivered maximally by the combustion engine at this speed. For example, the characteristic curve can be a speed-power characteristic curve or a speed-torque characteristic curve. In the speed-power characteristic curve, the maximum power is assigned to each speed, so that the maximum power for the actual speed can be determined directly. In the speed-torque characteristic curve, a maximum torque that can be delivered by the combustion engine at this speed is assigned to each speed, so that the corresponding maximum power can be determined as the product of the actual speed and the corresponding maximum torque.

According to one configuration, when determining the available total power, a maximum power rate of change is determined, at which the combustion engine is capable at an operating point characterized by the actual speed and/or an actual torque, wherein the available total power is determined such that it changes with respect to a previous available total power determined at an earlier point in time, while observing the maximum rate of change. Maximum power rate of change is to be understood in the sense of a maximum power rate of change in terms of magnitude, i.e., for negative rates of change it is the smallest (most negative) power rate of change. The maximum power rate of change can be determined from a maximum torque rate of change. The maximum power rate of change or the maximum torque rate of change indicates a temporal rate at which the combustion engine can change the power or the torque at a certain delivered power or at a certain delivered torque and a certain speed, i.e., it describes the dynamics or dynamic limits of the combustion engine. The maximum power rate of change or the maximum torque rate of change is, e.g., determined by an exhaust gas limit and/or a charge pressure inhibition of the combustion engine. The maximum power rate of change or the maximum torque rate of change can, e.g., be given by a characteristic map and/or a function, which assigns the maximum power rate of change or the maximum torque rate of change to a speed and a power. For positive changes (i.e., power increase or torque increase) and negative changes (i.e., power reduction or torque reduction), the maximum power rates of change can be different in magnitude.

According to one configuration, for each consumer of the at least one first consumer, the adjustment value is determined as a power adjustment and the actuating value is determined from the sum of the assigned consumer power and the power adjustment. According to an alternative configuration, for each consumer of the at least one first consumer, the adjustment value is determined as an actuating value adjustment, a preliminary actuating value is determined from the assigned consumer power and the actuating value is determined as the sum of the preliminary actuating value and the actuating value adjustment. It is assumed that each value of the consumer power corresponds to a corresponding actuating value with which the consumer power is consumed by the electric drive, wherein power losses can be taken into account. Correspondingly, a value for the actuating value adjustment also corresponds to a value for the power adjustment, so that the two options of this configuration are essentially equivalent and differ in the point at which the adjustment value is taken into account. In particular, each electric drive comprises an electric machine, wherein the actuating value is a torque that is to be delivered by the electric machine. With a given speed of the electric machine (e.g., measured with an encoder and known in an inverter control), the consumer power is then equal to the product of speed and torque, wherein additionally a power loss can be taken into account (e.g.: consumer power equals power loss plus speed times torque). The product of speed and actuating value adjustment can here be regarded as a corresponding power adjustment.

According to one configuration, the at least one first consumer includes two or more first consumers, wherein the adjustment values are given as power adjustments or corresponding power adjustments are determined for the adjustment values, wherein the adjustment values are determined such that the power adjustments of all first consumers are equal or such that the quotients of power adjustment and consumer power of all first consumers are equal. Correspondingly, the assigned consumer powers of all first consumers are influenced equally, which is, e.g., expedient if a coordinated movement of several components is to be effected by the various first consumers.

According to one configuration, the at least one first consumer includes two or more first consumers to which different priorities are assigned, wherein the adjustment values are given as power adjustments or corresponding power adjustments are determined for the adjustment values, wherein the adjustment values are determined such that the power adjustment of a first consumer with low priority is higher than the power adjustment of a first consumer with high priority, or such that the power adjustment of a first consumer with low priority relative to the consumer power assigned to it is higher than the power adjustment of a first consumer with high priority relative to the consumer power assigned to it. This configuration makes it possible to influence the assigned consumer powers of different consumers to different extents, for example, to supply “more important” consumers, which have a corresponding high priority, preferentially with power and to first change the assigned power of another consumer with low priority. According to the second option, for a consumer with low priority, the quotient of its power adjustment to its consumer power is higher or greater than the quotient of power adjustment to consumer power for a first consumer with high priority. In particular, the power adjustments of first consumers with the same priority are equal or the quotients of the respective power adjustment and consumer power of first consumers with the same priority are equal.

According to one configuration, the plurality of consumers include at least one second consumer, which is different from the at least one first consumer, wherein for each consumer of the at least one second consumer, an actuating value of the electric drive is determined from the consumer power assigned to the respective second consumer. It applies in particular that each of the plurality of consumers is either a first consumer or a second consumer. I.e., the union of the subset formed by the at least one first consumer with the subset formed by the at least one second consumer shall be equal to the set of all consumers.

According to one configuration, the electric drive of the at least one first consumer and, if applicable, the electric drive of the at least one second consumer is/are controlled with the respective determined actuating value. The actuating values are, for example, torques that are to be delivered by electric machines included in the electric drives.

According to one configuration, for each consumer of the plurality of consumers, a requested power is determined and, when determining the available total power, a power interval is determined in which the available total power to be determined can lie. If the sum of the requested powers lies within the power interval, the available total power is determined as equal to the sum of the requested powers. If the sum of the requested powers lies above an upper limit of the power interval, the available total power is determined as equal to the upper limit of the power interval, and if the sum of the requested powers lies below a lower limit of the power interval, the available total power is determined as equal to the lower limit of the power interval. The power interval is determined in particular based on the maximum power of the combustion engine at a given actual speed and/or based on the maximum power rate of change at a given actual speed.

According to one configuration, if the sum of the requested powers is equal to the available total power, the assigned consumer powers are determined as equal to the requested powers of the respective consumers, and/or if the sum of the requested powers is not equal to the available total power, the requested powers are adjusted to determine the assigned consumer powers, so that the sum of the assigned consumer powers or the adjusted requested powers is equal to the available total power. The first case occurs when the sum of the requested powers lies within the power interval. The second case occurs when the sum of the requested powers does not lie within the power interval, i.e., lies below the lower limit or above the upper limit.

An inventive computing unit, e.g. a control unit of a mobile work machine or a drive system of a mobile work machine, is, in particular program-technically, configured to carry out an inventive method.

The implementation of an inventive method in the form of a computer program or computer program product with program code for carrying out all method steps is also advantageous, as this causes particularly low costs, especially if an executing control unit is also used for other tasks and is therefore present anyway. Suitable data carriers for providing the computer program are in particular magnetic, optical and electrical storage media, such as, e.g., hard disks, flash memories, EEPROMs, DVDs, etc. A download of a program via computer networks (Internet, intranet, etc.) is also possible.

Further advantages and configurations of the disclosure result from the description and the accompanying drawing.

It is understood that the features mentioned above and those yet to be explained below can be used not only in the combination indicated in each case, but also in other combinations or in isolation, without departing from the scope of the present disclosure.

The disclosure is schematically represented by way of exemplary embodiments in the drawing and will be described in detail below with reference to the drawing.

### BRIEF DESCRIPTION OF THE DRAWINGS

FIG. 1 shows a drive system of a mobile work machine, in which an inventive method is applicable.

FIG. 2 shows a flowchart of a method according to an embodiment of the disclosure.

### DETAILED DESCRIPTION

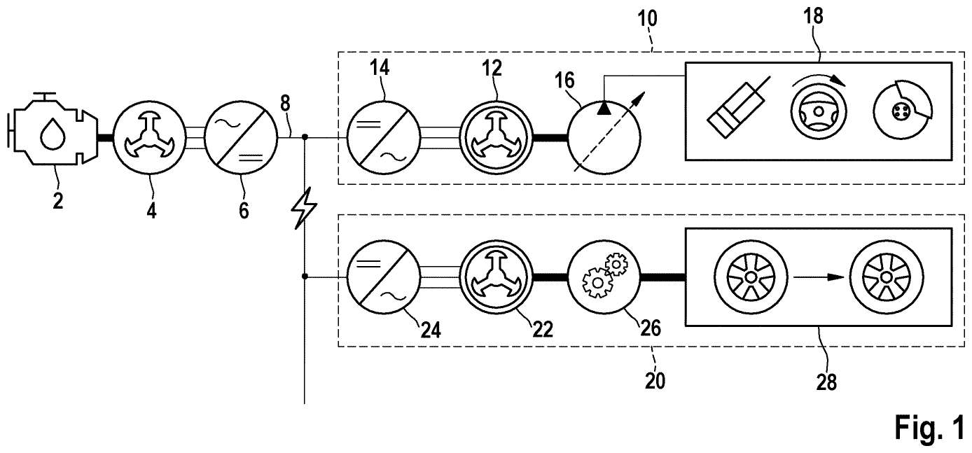

FIG. 1 shows a drive system of a mobile work machine, in which an inventive method is applicable. The drive system can also be referred to as a hybrid drive system.

The drive system has a combustion engine 2 and an electric generator 4 (i.e., an electric machine), which is mechanically coupled to the combustion engine 2 (e.g., via a shaft and/or a transmission) and is driven by it. An AC voltage or an AC current generated by the generator 2 is fed into an electric DC link 8 via a rectifier 6 or inverter. The combustion engine 2 is in particular a diesel engine. The combustion engine 2 is in particular regulated by a speed control corresponding to a setpoint speed, i.e., an actual speed of the combustion engine is detected, e.g., by a speed sensor on the combustion engine 2 or on the generator 4, and the supply of fuel and air to the combustion engine is controlled, so that a deviation between the actual speed and the setpoint speed is minimized or brought to zero. The generator 2 or rectifier 6 is, e.g., regulated or controlled with a field-oriented control, wherein the voltage in the DC link is regulated to a setpoint voltage.

The drive system further has several consumers, in the figure for example a first consumer 10 and a second consumer 20, which are connected to the electric DC link 8, i.e., are supplied with electric energy via it. Each consumer comprises an electric drive, which has an electric machine 12, 22 and an AC converter 14, 24 or inverter, wherein the electric machine 12, 22 is electrically connected to the DC link via the AC converter 14, 24. The electric machines in turn drive (directly or indirectly) one or more components of the work machine, i.e., the movement of the components. The components can be components fixedly arranged on the work machine and/or they can be couplable components or attachments (such as an agricultural attachment coupled to a tractor), wherein the coupling can be mechanical (e.g., via a PTO shaft) or hydraulic (e.g., via hydraulic connections).

The first consumer 10 has, for example, a hydraulic pump 16, which conveys pressure medium to one or more hydraulically driven components 18. In the figure, a hydraulic cylinder, with which, for example, a boom of the work machine is moved, a hydraulic steering and a hydraulic brake are symbolically represented. The hydraulic pump 16 is coupled to the electric machine 12 and is driven by it. The second consumer 20 has, for example, a transmission 26, which is coupled to the electric machine 22 and via which a mechanically driven component 28 is driven; for example, wheels of a travel drive are symbolically represented.

In general, the case can temporarily occur that a consumer does not draw any electric energy from the DC link, but feeds electric energy into the DC link. For example, the second consumer 20 (travel drive) could generate electric energy (recuperate) during a braking process or a downhill drive. If this electric power is not consumed by another consumer, the generator acts as an electric motor and the combustion engine as a motor brake.

From control inputs of an operator (e.g., via a pedal or a joystick, with which in the case of a travel drive the travel speed is controlled or in the case of a hydraulic cylinder the speed of a boom is controlled) and/or control signals of an automatic control function, power requests for the consumers 10, 20 (requested electric powers of the consumers) arise in order to achieve the desired movement corresponding to the control inputs or control signals. A power request can temporarily also have negative values, corresponding to the situation that a consumer feeds electric power into the DC link.

In the electric DC link 8, in particular, no buffer storage, such as a battery, is provided, so that an electric capacitance of the DC link is formed only by voltage-smoothing capacitors, which, for example, have a total capacitance of less than 1 Wh. Since in a work machine the power called up by the consumers depending on the operating situation can be well over 10 kW and further up to over 100 kW, and since the electric machines of the consumers have a higher dynamic than the combustion engine, instabilities can occur in the drive system due to the relatively low capacitance of the DC link. For example, a speed drop of the combustion engine could occur if load requests of the consumers suddenly increase.

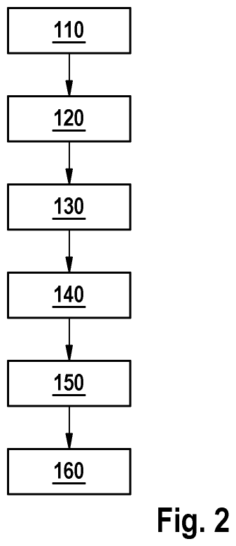

FIG. 2 shows a flowchart of a method according to an embodiment of the disclosure. The method relates to a drive system of a work machine (as shown by way of example in FIG. 1), which has a combustion engine, in particular a diesel engine, an electric generator, an electric DC link and several consumers with an electric drive. The combustion engine is coupled to the electric generator to drive it. The electric generator is connected to the electric drives of the consumers via the DC link to supply them with electric energy. The combustion engine is regulated by a speed control corresponding to a setpoint speed. An actual speed of the combustion engine is thus determined (e.g., by a speed sensor or encoder on the combustion engine or on the generator) and the combustion engine (i.e., the fuel/air supply) is controlled so that the actual speed is regulated to the setpoint speed. The setpoint speed is, e.g., chosen such that a high efficiency of the combustion engine is present. The speed control of the combustion engine is in particular carried out continuously by a control unit or a controller, e.g., an engine control unit. The following method is in particular carried out by a control unit (i.e., computing unit or electronic controller) of the drive system or the work machine.

In an optional step 110, a requested power is determined for each of the consumers (or a value for the requested power of the consumer, e.g., in kW). For this purpose, e.g., control inputs of an operator and/or control signals of a consumer control, in particular an at least partially automatic consumer control, can be evaluated. If, for example, in a consumer (e.g., consumer 10 in FIG. 1) a hydraulic pump is driven by an electric machine, the required power can be determined as requested power from a desired delivered volume flow of the hydraulic pump and a load pressure. The desired delivered volume flow of the hydraulic pump results as a sum-volume flow, which is necessary to move hydraulic consumers (hydraulic cylinder or the like) at a speed corresponding to a user input.

Data of the electric drive can also be evaluated, e.g., a control signal for a requested torque, with which an electric machine or the associated inverter is controlled, in combination with the speed of the electric machine. In the requested powers, the efficiency of the respective elements, in particular of the electric drive, can be taken into account.

In step 120, an available total power (or a value for the available total power, e.g., in kW) is determined. The available total power is the total power that is available for the consumers, i.e., that is available in the DC link. This is based on an available power of the combustion engine, which is in particular reduced by power losses caused by the mechanical coupling and/or the generator and/or the rectifier or inverter and/or any other occurring power losses. For example, this is based on a previous available total power, i.e., an available total power determined at a previous point in time, and from this a power interval is determined in which the current, i.e., the available total power to be determined, can lie. In particular, such a power interval is conditioned by the technical capabilities of the combustion engine. It is assumed here that the method is repeated continuously and in particular by the control unit at points in time between which certain time intervals lie, e.g., on a time grid with uniform time intervals between the points in time, whereby, for example, the requested powers and/or the actual speed can change between the points in time.

If the sum of the requested powers lies within the power interval, the available total power is determined as equal to the sum of the requested powers. If the sum of the requested powers lies above an upper limit of the power interval, the available total power is determined as equal to the upper limit of the power interval. If the sum of the requested powers lies below a lower limit of the power interval, the available total power is determined as equal to the lower limit of the power interval.

When determining the power interval, in particular a static and/or a dynamic power limit can be taken into account. A static power limit is given by the maximum power that the combustion engine can deliver at a given speed. The maximum power can be determined, e.g., from a speed-power characteristic curve for the maximum power or a speed-torque characteristic curve for a maximum deliverable torque. Such characteristic curves can, e.g., be taken from data sheets of the combustion engine and/or be determined by tests, for instance on a test bench, and be stored by the control unit. A dynamic power limit is given by the maximum rate of change of the power or the torque, at which the combustion engine is capable at a given speed and/or a given torque (the rate of change is, e.g., restricted by a smoke limit and a charge pressure inhibition). This can, e.g., be taken from a characteristic map, which assigns a maximum rate of change or, if the maximum rates of change for changes downwards and upwards are different, two maximum rates of change to each speed and each power and/or each torque. Thus, one (or two) maximum power rate(s) of change can be determined.

Starting from the previous available total power, i.e., an available total power determined at a previous point in time, the power interval results accordingly at a given actual speed, in which the available total power to be determined (i.e., for the current point in time) can lie (i.e., can actually be achieved by the combustion engine). The power interval is thereby determined such that the static and/or the dynamic power limit are observed, wherein the above-mentioned power losses are taken into account. Correspondingly, the upper limit of the power interval is determined by the smaller of the maximum power and the sum of the previous available total power and the maximum power rate of change times the time difference between the current and the previous point in time, or given after deduction of the mentioned power losses. The lower limit of the power interval is determined by the difference between the previous available total power and the maximum power rate of change times the time difference between the current and the previous point in time, or given after deduction of the mentioned power losses. The maximum power rate of change for the lower limit can be different from the maximum power rate of change for the upper limit.

In step 130, a respective consumer power is assigned to each of the consumers, such that the sum of the assigned consumer powers is equal to the available total power. It is in particular based on the requested powers of the consumers from step 110. If the sum of the requested powers is equal to the available total power, the requested powers are assigned to the consumers as consumer powers. If the sum of the requested powers is not equal to the available total power, an adjustment of the requested powers takes place to determine the assigned consumer powers, so that their sum after the adjustment is equal to the available total power. The adjustment can be done in various ways. For example, all requested powers can be multiplied by the same factor to determine the assigned consumer powers. The factor is given as the ratio of available total power to the sum of the requested powers. Accordingly, in this example, the requested powers are changed by the same percentage to obtain the assigned consumer powers. In another example, the requested powers can be changed by a non-uniform percentage to obtain the assigned consumer powers. For example, different consumers can have different priorities, wherein for consumers with high priority (e.g., a steering or a brake system) the requested powers are changed by a smaller percentage or not at all to obtain their assigned consumer powers, and for consumers with low priority the requested powers are changed by a larger percentage to obtain their assigned consumer powers. The adjustment of the assigned consumer powers to the available total power can be regarded as a (consumer-side) feed-forward control.

In step 140, for at least one (first) consumer, an adjustment value is determined by way of a controller from a control difference between the actual speed and the setpoint speed of the combustion engine. The adjustment value can in particular be determined as a power adjustment or power adjustment value or as an actuating value adjustment or actuating value adjustment value.

In the case that the at least one consumer includes several consumers, a respective adjustment value is determined for each, wherein the adjustment values are generally different for different consumers and can be independent of each other. In this case, i.e., adjustment values are determined for several consumers, a single controller or several controllers can be used. If a single controller is used, the individual adjustment values for the different consumers can be determined from its output value, e.g., by multiplication with a respective consumer-specific factor, wherein the factor, in particular if priorities are assigned to the consumers, can be dependent on a priority of the respective consumer. In addition to multiplication with factors, other mappings are of course also possible, in particular those that ensure that certain conditions for the respective consumers are met, e.g., that a predetermined minimum power is not fallen short of. In the case of several controllers (which, for example, have different control behaviors), in turn at least one of these several controllers can be provided for one single consumer each and/or at least one of these several controllers can be provided for several consumers. If consumer-specific factors or the like are used, these can in particular include the corresponding assigned consumer powers, so that the adjustment values can be determined as relative values, related to the respective consumer powers.

The controller or controllers can in particular include one of the following controllers: a P-controller, a PI-controller, a PID-controller (P: Proportional, I: Integral, D: Differential). In the case of several controllers, different of these controllers can be used and/or different controller parameters or controller gains can be used.

Optionally, in the case that the at least one consumer includes several consumers, these several consumers can have priorities that are different for at least two of these several consumers. A level of the adjustment values, in particular a relative level of the adjustment values, can then be determined according to the priorities, i.e., adjustment values of consumers with low priority are (relatively) higher or greater than adjustment values of consumers with high priority. For example, in the above example of an attachment coupled to a tractor, a higher priority can be assigned to the consumer via which the attachment is driven than to a consumer via which the travel drive of the tractor is driven. If the actual speed of the combustion engine then falls below the setpoint speed, the power assigned to the consumer of the travel drive is preferentially reduced, so that first the travel speed is reduced, which can indirectly also lead to a reduced power request of the attachment.

In step 150, for each first consumer, an actuating value for the electric drive of the respective first consumer is determined from the consumer power assigned to the respective first consumer and the adjustment value. As an actuating value, in particular a torque to be delivered by the electric machine of the respective electric drive is used, so that at a given speed of the electric machine a corresponding power can be determined as the product of torque (actuating value) and speed (with possible additional consideration of power loss) or from a power (e.g., assigned consumer power) a torque can be determined (apart from power loss as power by speed).

If, according to the first possibility mentioned with respect to step 140, the adjustment value is determined as a power adjustment (or power adjustment value), the assigned consumer power is changed by the power adjustment, in particular the power adjustment is added to the assigned consumer power to obtain a changed assigned consumer power. The actuating value is then determined from the changed assigned consumer power.

If, according to the second possibility mentioned with respect to step 140, the adjustment value is determined as an actuating value adjustment (or actuating value adjustment value), a preliminary actuating value is first determined from the assigned consumer power and this preliminary actuating value is then changed by the actuating value adjustment, in particular the actuating value adjustment is added to the preliminary actuating value to determine the actuating value.

In step 160, the electric drive of the at least one (first) consumer or its electric machine is controlled with the actuating value determined in step 150.

By the described procedure, in which adjustment values are taken into account, instabilities due to unforeseeable power fluctuations of consumers (e.g., a hydraulic accumulator charging circuit for a service brake) can be avoided or at least reduced. The at least one first consumer can, but need not, include all consumers.

Besides the at least one first consumer, for which an adjustment value is determined and taken into account in the determination of the actuating value, the plurality of consumers can include one or more consumers for which no adjustment value is determined. Such consumers are also referred to as second consumers. Second consumers or their electric drives are controlled with actuating values that are determined directly from the assigned consumer powers or correspond to these. Referring again to the above example, the consumer with which the attachment is driven can, for example, also be a second consumer.

What is claimed is:

1. A method in a drive system of a work machine, which comprises a combustion engine, an electric generator, an electric DC link and a plurality of consumers with an electric drive, wherein the combustion engine is coupled to the electric generator to drive it, wherein the electric generator is connected via the DC link to the electric drives of the consumers to supply them with electric energy, and wherein the combustion engine is regulated by a speed control corresponding to a setpoint speed, the method comprising:
determining a total power of the combustion engine available in the DC link; and
assigning a respective consumer power to each consumer of the plurality of consumers such that the sum of the consumer powers is equal to the available total power,
wherein the plurality of consumers includes at least one first consumer, further comprising for each consumer of the at least one first consumer:
determining an adjustment value from a control difference between an actual speed and the setpoint speed of the combustion engine, and
determining an actuating value for the electric drive from the consumer power assigned to the respective first consumer and the adjustment value.

2. The method according to claim 1, wherein:
in determining the available total power, a maximum power is determined which can be delivered by the combustion engine at the actual speed, and
the available total power is determined as less than or equal to the maximum power at the actual speed.

3. The method according to claim 1, wherein:
in determining the available total power, a maximum power rate of change is determined, at which the combustion engine is capable at a current operating point, which is characterized by the actual speed and/or an actual torque, and
the available total power is determined such that it changes with respect to a previous available total power determined at an earlier point in time, while observing the maximum rate of change.

4. The method according to claim 1, wherein:
for each consumer of the at least one first consumer, the adjustment value is determined as a power adjustment and the actuating value is determined from the sum of the assigned consumer power and the power adjustment, or
for each consumer of the at least one first consumer, the adjustment value is determined as an actuating value adjustment, a preliminary actuating value is determined from the assigned consumer power, and the actuating value is determined as the sum of the preliminary actuating value and the actuating value adjustment.

5. The method according to claim 1, wherein:
the at least one first consumer includes at least two first consumers,
the adjustment values are given as power adjustments or corresponding power adjustments are determined for the adjustment values, and
the adjustment values are determined such that the power adjustments of the at least two first consumers are equal, or such that the quotients of power adjustment and consumer power of the at least two first consumers are equal.

6. The method claim 1, wherein:
the at least one first consumer includes at least two first consumers to which different priorities are assigned,
the adjustment values are given as power adjustments or corresponding power adjustments are determined for the adjustment values, and
the adjustment values are determined such that the power adjustment of a first of the at least two first consumers with low priority is higher than the power adjustment of a second of the at least two first consumers with high priority, or such that the power adjustment of a first of the at least two first consumers with low priority relative to the consumer power assigned to it is higher than the power adjustment of a second of the at least two first consumers with high priority relative to the consumer power assigned to it.

7. The method according to claim 1, wherein:
the plurality of consumers include at least one second consumer, which is different from the at least one first consumer, and
for each consumer of the at least one second consumer, an actuating value of the electric drive is determined from the consumer power assigned to the respective second consumer.

8. The method according to claim 7, wherein:
the electric drive of the at least one first consumer, and the electric drive of the at least one second consumer is controlled with the respective determined actuating value.

9. The method according to claim 1, wherein:
for each consumer of the plurality of consumers a requested power is determined, and
in determining the available total power:
a power interval is determined in which the available total power to be determined can lie,
if the sum of the requested powers lies within the power interval, the available total power is determined as equal to the sum of the requested powers,
if the sum of the requested powers lies above an upper limit of the power interval, the available total power is determined as equal to the upper limit of the power interval, and
if the sum of the requested powers lies below a lower limit of the power interval, the available total power is determined as equal to the lower limit of the power interval.

10. The method according to claim 9, wherein:
if the sum of the requested powers is equal to the available total power, the assigned consumer powers are determined as equal to the requested powers of the respective consumers, and
if the sum of the requested powers is not equal to the available total power, the requested powers are adjusted to determine the assigned consumer powers, so that the sum of the assigned consumer powers or the adjusted requested powers is equal to the available total power.

11. A computing unit comprising a processor, which is configured to execute the method according to claim 1.

12. A computer program comprising instructions which, when the program is executed by a computer, cause it to carry out the method according to claim 1.

13. A computer-readable data carrier on which the computer program according to claim 12 is stored.

14. The method according to claim 1, wherein the combustion engine is a diesel engine.
